(19) United States
(12) Patent Application Publication
(10) Pub. No.: US 2004/0139424 A1
(43) Pub. Date: Jul. 15, 2004

(54) Method for execution context reification and serialization in a bytecode based run-time environment

(75) Inventor: Serguei Mourachov, Vancouver (CA)

Correspondence Address: OYEN, WIGGS, GREEN & MUTALA, 480 - THE STATION, 601 WEST CORDOVA STREET, VANCOUVER, BC, V6B 1G1, CA

(73) Assignee: Velare Technologies Inc., Vancouver (CA)

(21) Appl. No.: 10/340,657

(22) Filed: Jan. 13, 2003

(51) Int. Cl. G06F 9/44; G06F 9/45

(52) U.S. Cl. 717/118; 717/148

(57) ABSTRACT

A method of executing bytecode by means of a secondary interpreter using the services of the primary virtual machine is disclosed. This facilitates the development and execution of long-lived processes that require execution context serialization.

### TECHNICAL FIELD

The invention relates to the field of computer programmming and processing and more particularly to methods for processing bytecodes within a computer system.

### BACKGROUND

Bytecode is currently the dominant type of portable code or mobile code. Portable or mobile code are types of code which permit a program to be run on a variety of different central processing units, such as CPU's using Windows™ or UNIX™-based or UNIX™-like operating systems, without modification. Bytecode accomplishes this by providing a program to translate the portable code to the code used by the local CPU at runtime. Thus the program is written for an imaginary CPU and this is then translated for the actual CPU at runtime.

Currently the design of advanced distributed software systems may involve development of long-running processors that require state preservation during asynchronous method invocations. The time interval between invocations may be on the order of magnitude of days or even years. The standard solution in such cases is to use stateful persistent objects and an event-driven execution model. This approach, in the case of complex interaction, tends to be difficult for software development and maintenance because process logic implementation is scattered across multiple event handling methods. Furthermore, such an approach makes it very difficult to implement the process composition. It would therefore be desirable to implement execution context reification to simplify development of such systems and allow program flow of asynchronous events using a synchronous paradigm.

Currently the most prevalent bytecode formats are Sun Microsystem Inc.'s Java Virtual Machine (JVM) and Microsoft's Common Language Runtime (CLR). Such systems have a rich functionality to access their Run-Time Type Information (RTTI) using a mechanism called reflection. However these systems do not allow serializing execution state of the process running inside the Virtual Machine. It is therefore desirable to build a bytecode interpreter which has execution context reification mechanisms for these systems.

### SUMMARY OF INVENTION

The present invention facilitates development and execution of long-lived processes that require execution context serialization such as applications with asynchronous interaction with the outside world or mobile agents. The method can be implemented in any runtime environment that uses bytecode-based execution file format, such as Sun Microsystem Inc.'s Java Virtual Machine (JVM) and Microsoft's Common Language Runtime (CLR). The invention provides a secondary bytecode interpreter that executes specially marked methods using services of the Primary Virtual Machine (PVM) such as object management, garbage collecting, multithreading and the like. The process execution context is implemented as first-class-object of the PVM and is used by the secondary interpreter to represent its state. At any moment the execution of the interpreted process can be stopped and the execution context can be serialized and saved to any storage, such as memory, database or file system, or can be sent across the network for process continuation or storage. Execution context can be restored from its serialized form and execution can be continued from the exact point where it was stopped.

### BRIEF DESCRIPTION OF DRAWINGS

In drawings which illustrate a preferred embodiment of the invention:

FIG. 1 is a schematic block diagram showing the structure of the prior art bytecode based execution environment;

FIG. 2 is a schematic block diagram showing the structure of the secondary interpreter of the invention implemented as a process executed by the Primary Virtual Machine;

FIG. 3 is a schematic block diagram showing the structure of the secondary interpreter of the invention implemented as an external process running outside of the Primary Virtual Machine;

FIG. 4 is a schematic flow diagram illustrating the bytecode execution process using the invention;

FIG. 5 is a flow chart illustrating the control flow of the secondary interpreter; and

FIG. 6 is a schematic flow chart illustrating the Secondary Interpreter lifecycle in case of multiple PVM processes.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

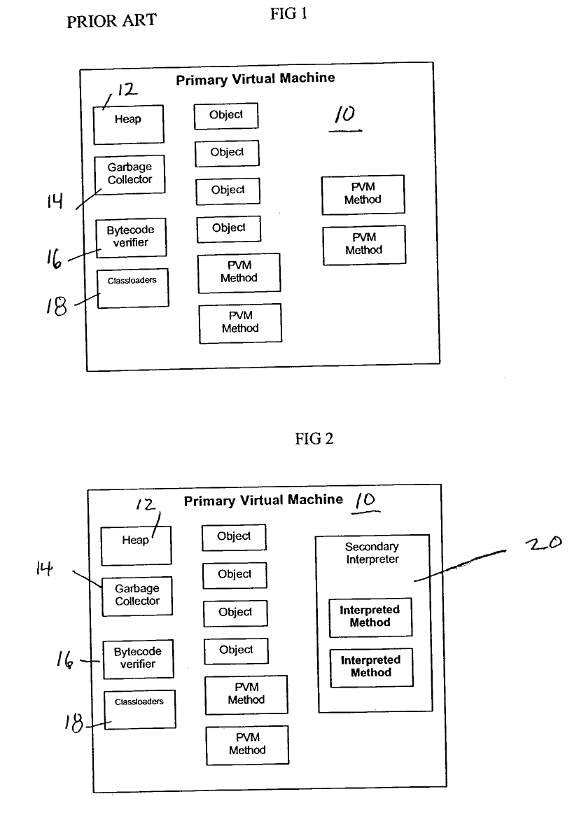

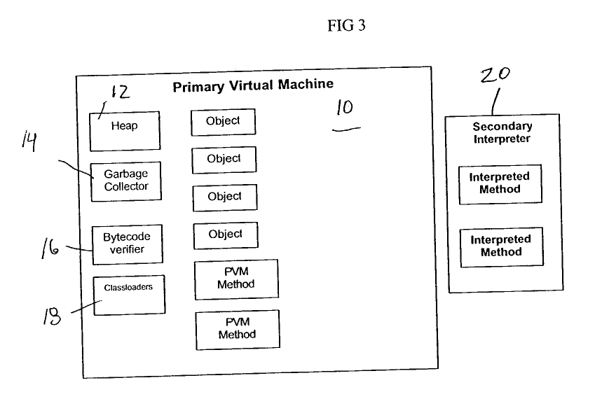

FIG. 1 illustrates a common bytecode-based execution environment, such as Sun Microsystem Inc.'s Java Virtual Machine (JVM) and Microsoft's Common Language Runtime (CLR). The Primary Virtual Machine 10 executes all object methods using various service modules such as Heap 12, Garbage Collector 14, Bytecode Verifier 16, Classloaders 18, etc. The present invention provides a method of bytecode execution when the main execution branch, which represents itself as an asynchronously interrupted process, is interpreted by a secondary interpreter and all side execution branches are executed by the PVM. The secondary interpreter can be implemented as a PVM process as shown in FIG. 2 or as a native code module as shown in FIG. 3.

As shown in FIG. 2, the secondary interpreter 20 is implemented as a process that runs inside the Primary VM. The Secondary Interpreter 20 executes specially marked object methods using the Primary VM services such as Access to Objects using reflection mechanism, Heap 12, Garbage Collector 14, Bytecode Verifier 16 and Classloaders 18. In FIG. 3, the Secondary Interpreter 20 is implemented as an external process that runs outside of the Primary VM, possibly as a native module.

The secondary interpreter uses an execution context object that keeps the state of the process. The Execution Context Object is a common object with a set of fields and methods that allow control of execution such as process stopping, resuming, serialization, de-serialization and the like. The main execution branch of the interpreted process consists of a sequence of method invocations, where all such methods are discriminated using different discrimination mechanisms and are executed by the secondary interpreter. Discrimination can be based on different mechanisms, such as special code attributes, method name templates, class or namespace or it can be defined programmatically at runtime. All methods that are not discriminated are considered as side branches and the interpreter delegates their execution using reflection mechanism to the PVM for higher performance. Object management is provided by the PVM and the secondary interpreter updates object state using reflection mechanism during bytecode interpretation.

The process executed by the secondary interpreter can be interrupted at any point of bytecode interpretation. There are two ways to interrupt the process: from any outside thread accessing the interpreter and execution context methods, or from a process execution thread when the secondary interpreter reaches an interruption point. This interruption point can be defined by a method that is marked by a different discriminator than used to define interpreted methods. When the interpreter is interrupted, it stops bytecode execution and passes control to the method that started the interpreter. After the process interpretation has been stopped, its execution context can be serialized and/or stored or sent across the network and reactivated in its pre-stop state at any time. It is possible to implement various call back methods for the embedded interpreter, such as, but not limited to, method call, field modification, object creation and the like. This mechanism allows detailed control of the process execution by the developer.

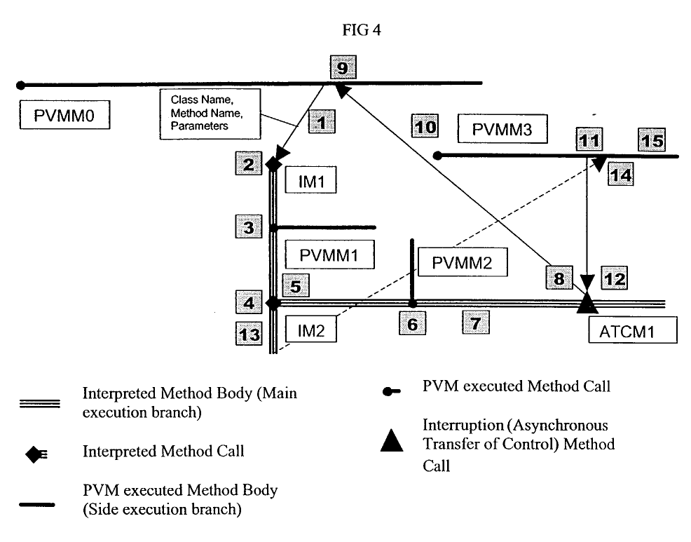

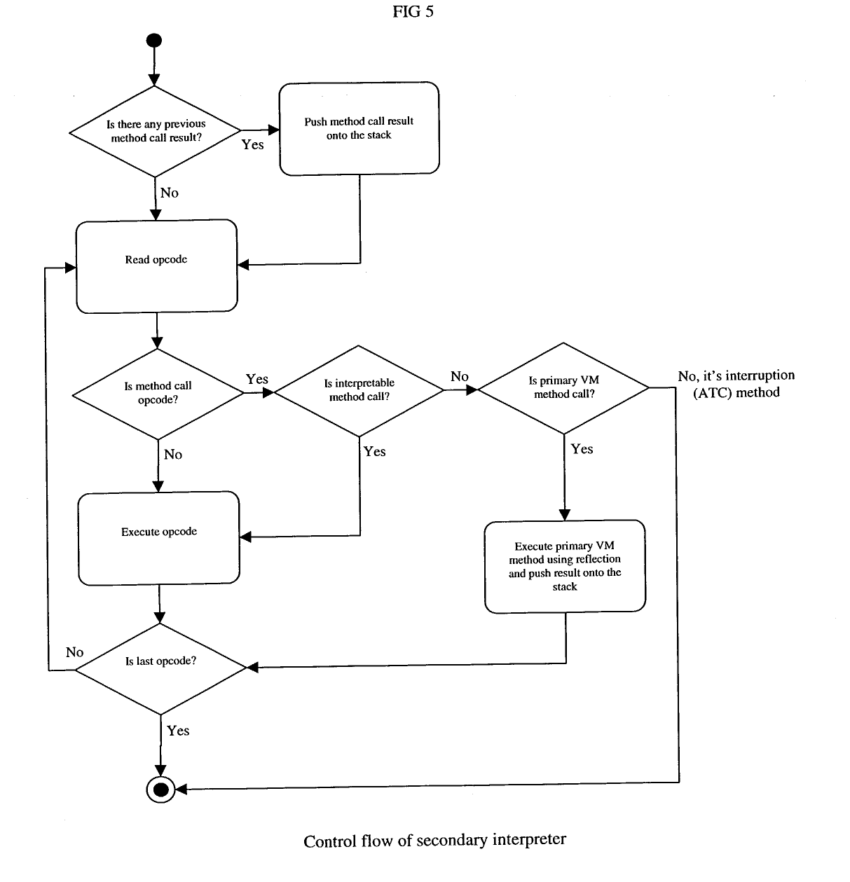

The bytecode execution process using the invention is illustrated in FIG. 4 as follows:

1. Normal Primary Virtual Machine method PVMM0 activates instance of the Secondary interpreter and passes class name, method name and parameter list to it.

2. Secondary interpreter loads bytecode for IM1 body in memory, pushes parameters on its process stack and starts interpreting method body.

3. Method IM1 contains call to method PVMM1 that is not marked as interpretable and execution of the method is delegated to Primary Virtual Machine.

4. After return from method PVMM1, method IM1 is interpreted until it reaches call to method IM2, which is marked as interpretable.

5. Secondary interpreter loads bytecode for IM2 body in memory and starts interpreting it.

6. Secondary interpreter reaches call to method PVMM2 that is not marked as interpretable and execution of the method delegated to Primary Virtual Machine.

7. Method PVMM2 returns and IM2 continues its execution by Secondary interpreter

8. Secondary interpreter reaches call to method ATCM1 that is marked as interruption method and returns control to method PVMM0

9. Method PVMM0 stores state of Secondary interpreter (in memory or in any other device or environment) and continue its normal execution.

10. New thread in the current PVM process or new PVM process can be started on the same or other machine that has access to the store where Secondary interpreter state is saved.

11. Method PVMM3 starts its execution. It retrieves and reactivates Secondary interpreter object (or its copy) and continues interpretation passing a value as simulated result of execution of method ATCM1.

12. Method IM2 accepts value passed from PVMM3 as result of ATCM1 and IM2 continues its execution by Secondary interpreter.

13. Method IM2 returns and IM1 continues its execution by Secondary interpreter.

14. Method IM1 returns and Secondary interpreter returns to method PVMM3.

15. Method PVMM3 continues its execution by Primary Virtual Machine.

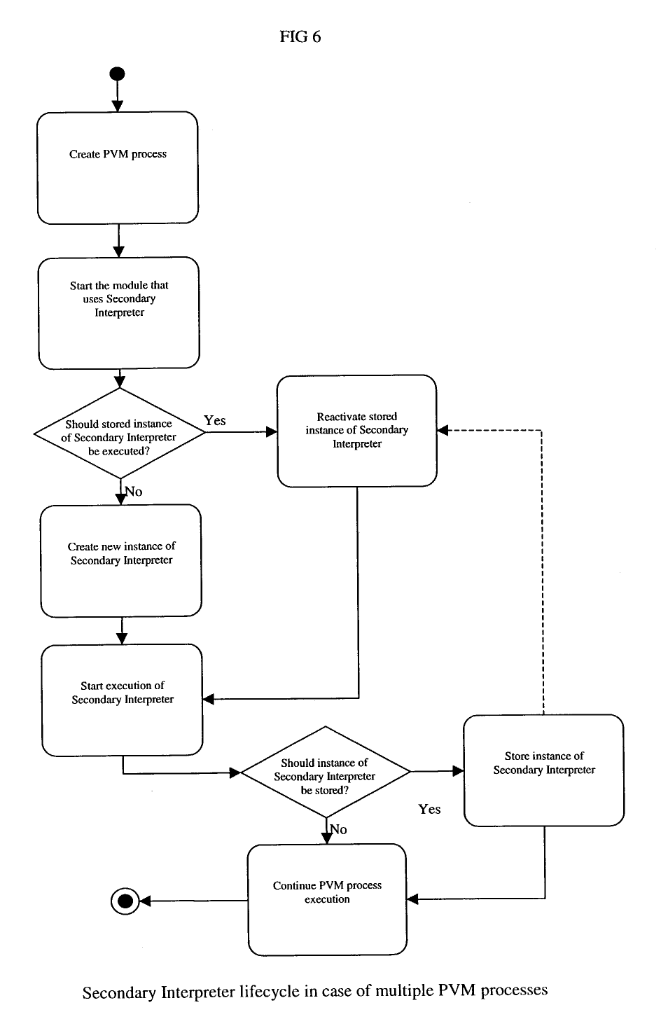

FIG. 5 by way of a flow chart illustrates the control flow of the secondary interpreter. In FIG. 6 a schematic flow chart illustrates the Secondary Interpreter lifecycle in the case of multiple PVM processes.

The following pseudo-code illustrates an implementation of the invention

```
/**
  * Class Sample illustrates use of secondary interpreter in a general
scenario
  */
public class Sample {
```

```
/**
  * Execution of this method will be delegated to PVM
  */
public void PVMM1( ){
```

/*Method Body */

```
}
/**
  * Execution of this method will be delegated to PVM
  */
public void PVMM2( ){
```

/*Method Body */

}
/**
* This method is marked by ATCStartSignal exception code

attribute and instead of its

* execution Secondary interpreter will pass control to the method

that started interpretation

*/
public int ATCM1( ) throws ATCStartSignal{

return 0;// Dummy method body that never will be executed

```
}
/**
  * This method is marked by ATCSignal exception code attribute
  * and will be executed by Secondary interpreter
  */
public void IM1(String data) throws ATCSignal{
```

PVMM1( ) ; // 3
IM2( ); // 4
// 13

```
}
/**
  * This method is marked by ATCSignal exception code attribute
  * and will be executed by Secondary interpreter
  */
public void IM2( ) throws ATCSignal{ // 5
```

PVMM2( ); // 6
// 7
//This call interrupts execution and passes control back to

method that created the SecondaryInterpreter

int n = ATCM1( ); // 8
// 12
System.out.println(“ATCM1 result = ”+n);

```
}
/**
  * This method creates new instance of SecondaryInterpreter
  * defining object, method and parameters values and starts
```

interpretation

*/
public void PVMM0( ) throws Exception{

Method startMethod = Sample.class.getMethod (“IM1”,new

Class [ ]{String.class});

Sample targetObject = new Sample( );
Object parameters = new Object [ ]{“start”};
SecondaryInterpreter secondaryInterPreter = new

SecondaryInterpreter(targetObject, startMethod, parameters); // 1

// MethodCall object contained information of ATC method call

such as method name,

// target object and values of parameters
MethodCall methodCall = secondaryInterpreter.start( ); // 2
//This call stores state of secondaryInterpreter in some store
secondaryInterpreter.store(“SomeStore”); // 9

}
/**
* This method restores state of secondaryInterpreter and continues

interpretation

```
  * passing simulated result of ATCM1 to IM2
  */
public void PVMM3( ) throws Exception{
```

// 11
SecondaryInterpreter secondaryInterpreter = new

SecondaryInterpreter( );

secondaryInterpreter.read(“SomeStore”);
Object atcMethodResult = new Integer(10);
MethodCall methodCall =

secondayInterpreter.resume(atcMethodResult); // 14

// 15

}

}

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of executing bytecode in a computer system having a primary virtual machine comprising providing a secondary interpreter adapted to use the services of the primary virtual machine.

2. The method of claim 1 comprising the step of discriminating between methods which are specially marked to be executed by said secondary interpreter and others which are delegated to said primary virtual machine for execution.

3. The method of claim 2 further comprising the step of defining a point of interruption of said interpretation process using said specially marked methods where there is asynchronous transfer of control.

4. The method of claim 3 further comprising the step of execution context reification and serialization.

5. The method of claim 4 further comprising the step of reactivation of serialized execution context.

6. The method of claim 5 further comprising the step of controlling process execution using interaction with said secondary interpreter.

7. A process for use in executing bytecode, the process comprising the steps of:
executing the bytecode of a first method on a primary virtual machine;
the first method activating a secondary bytecode interpreter;
the secondary bytecode interpreter executing the bytecode of at least one further method;
an interruption call transferring control back to the first method on the primary virtual machine and effecting storage and/or serialization of the secondary bytecode interpreter state; and,
wherein the first method, or an additional method, can subsequently reactivate execution of the bytecode of the at least one further method by the secondary bytecode interpreter.

8. The process as claimed in claim 7, wherein the secondary bytecode interpreter resides in the primary virtual machine.

9. The process as claimed in claim 8, wherein the secondary bytecode interpreter is a bytecode module.

10. The process as claimed in claim 7, wherein the secondary bytecode interpreter resides outside the primary virtual machine.

11. The process as claimed in claim 10, wherein the secondary bytecode interpreter is a native code module.

12. The process as claimed in claim 7, wherein the secondary bytecode interpreter utilizes services of the primary virtual machine.

13. The process as claimed in claim 7, wherein the at least one further method calls one or more other methods that are delegated for execution on the primary virtual machine, with execution of the at least one further method continuing thereafter.

14. The process as claimed in claim 7, wherein the interruption call is asynchronous.

15. The process as claimed in claim 7, wherein the secondary bytecode interpreter executes only specially marked methods.

16. The process as claimed in claim 7, wherein the secondary bytecode interpreter utilizes at least one object that contains execution context state.

17. The process as claimed in claim 7, wherein the secondary bytecode interpreter discriminates between methods to be executed by the secondary bytecode interpreter or delegated to the primary virtual machine.

18. The process as claimed in claim 7, wherein the secondary bytecode interpreter updates object states using reflection.

19. The process as claimed in claim 7, wherein execution of the bytecode of the at least one further method is interruptable at any point.

20. The process as claimed in claim 7, wherein the interruption call is made externally to the secondary bytecode interpreter.

21. The process as claimed in claim 7, wherein the interruption call results from the at least one further method.

22. The process as claimed in claim 7, wherein the interruption call is activated by the secondary bytecode interpreter during bytecode interpretation.

23. The process as claimed in claim 7, wherein the additional method is executed at the same or another location as the first method.

24. A system for executing bytecode, the system comprising:
(1) means to provide a primary virtual machine;
(2) storage means;
(3) at least one processor, the at least one processor being adapted to:
(a) execute the bytecode of a first method on the primary virtual machine;
(b) facilitate the first method to activate a secondary bytecode interpreter;
(c) facilitate the secondary bytecode interpreter to execute the bytecode of at least one further method;
(d) allow an interruption call to transfer control back to the first method on the primary virtual machine and effect storage and/or serialization of the secondary bytecode interpreter state in the storage means; and,
(e) allow the first method, or an additional method, to subsequently reactivate execution of the bytecode of the at least one further method by the secondary bytecode interpreter.

25. A system for executing bytecode, the system comprising:
means to execute the bytecode of a first method on a primary virtual machine, the first method activating a secondary bytecode interpreter, and the secondary bytecode interpreter executing the bytecode of at least one further method;
means to provide an interruption call transferring control back to the first method on the primary virtual machine;
storage means for saving the secondary bytecode interpreter state; and,
means to allow the first method, or an additional method, to subsequently reactivate execution of the bytecode of the at least one further method by the secondary bytecode interpreter.

26. The system as claimed in claim 25, wherein the secondary bytecode interpreter resides in the primary virtual machine.

27. The system as claimed in claim 25, wherein the secondary bytecode interpreter resides outside the primary virtual machine.

28. The system as claimed in claim 26, wherein the secondary bytecode interpreter is a bytecode module.

29. The system as claimed in claim 27, wherein the secondary bytecode interpreter is a native code module.

30. The system as claimed in claim 25, wherein the interruption call is asynchronous.

31. The system as claimed in claim 25, wherein the secondary bytecode interpreter executes only specially marked methods.

32. The system as claimed in claim 25, wherein the secondary bytecode interpreter utilizes at least one object that contains execution context state.

33. The system as claimed in claim 25, wherein the secondary bytecode interpreter discriminates between methods to be executed by the secondary bytecode interpreter or delegated to the primary virtual machine.

34. The system as claimed in claim 25, wherein the secondary bytecode interpreter updates object states using reflection.

35. The system as claimed in claim 25, wherein execution of the bytecode of the at least one further method is interruptable at any point.

36. The system as claimed in claim 25, wherein the additional method is executed at the same or another location as the first method.

37. A computer readable medium of instructions for executing bytecode, the computer readable medium of instructions adapted to:
execute the bytecode of a first method on a primary virtual machine, the first method activating a secondary bytecode interpreter;
provide the secondary bytecode interpreter to execute the bytecode of at least one further method;
receive an interruption call transferring control back to the first method on the primary virtual machine and effect storage and/or serialization of the secondary bytecode interpreter state; and,
use the first method, or an additional method, to subsequently reactivate execution of the bytecode of the at least one further method by the secondary bytecode interpreter.

38. A computer program product for use in executing bytecode, said computer program product comprising:
a computer usable medium having computer readable program code means embodied in said medium for:
executing the bytecode of a first method on a primary virtual machine;
the first method activating a secondary bytecode interpreter;
the secondary bytecode interpreter executing the bytecode of at least one further method;
an interruption call transferring control back to the first method on the primary virtual machine and effecting storage and/or serialization of the secondary bytecode interpreter state; and,
wherein the first method, or an additional method, can subsequently reactivate execution of the bytecode of the at least one further method by the secondary bytecode interpreter.

39. The computer program product as claimed in claim 38, wherein the secondary bytecode interpreter resides in the primary virtual machine.

40. The computer program product as claimed in claim 39, wherein the secondary bytecode interpreter is a bytecode module.

41. The computer program product as claimed in claim 38, wherein the secondary bytecode interpreter resides outside the primary virtual machine.

42. The computer program product as claimed in claim 41, wherein the secondary bytecode interpreter is a native code module.

43. The computer program product as claimed in claim 38, wherein the secondary bytecode interpreter utilizes services of the primary virtual machine.

44. The computer program product as claimed in claim 38, wherein the at least one further method calls one or more other methods that are delegated for execution on the primary virtual machine, with execution of the at least one further method continuing thereafter.

45. The computer program product as claimed in claim 38, wherein the interruption call is asynchronous.

46. The computer program product as claimed in claim 38, wherein the secondary bytecode interpreter executes only specially marked methods.

47. The computer program product as claimed in claim 38, wherein the secondary bytecode interpreter utilizes at least one object that contains execution context state.

48. The computer program product as claimed in claim 38, wherein the secondary bytecode interpreter discriminates between methods to be executed by the secondary bytecode interpreter or delegated to the primary virtual machine.

49. The computer program product as claimed in claim 38, wherein the secondary bytecode interpreter updates object states using reflection.

50. The computer program product as claimed in claim 38, wherein execution of the bytecode of the at least one further method is interruptable at any point.

51. The computer program product as claimed in claim 38, wherein the interruption call is made externally to the secondary bytecode interpreter.

52. The computer program product as claimed in claim 38, wherein the interruption call results from the at least one further method.

53. The computer program product as claimed in claim 38, wherein the interruption call is activated by the secondary bytecode interpreter during bytecode interpretation.

54. The computer program product as claimed in claim 38, wherein the additional method is executed at the same or another location as the first method.

55. An article comprising:
a computer readable modulated carrier signal;
means embedded in said signal for use in executing bytecode, said means comprising means for:
executing the bytecode of a first method on a primary virtual machine;
the first method activating a secondary bytecode interpreter;
the secondary bytecode interpreter executing the bytecode of at least one further method;
an interruption call transferring control back to the first method on the primary virtual machine and effecting storage and/or serialization of the secondary bytecode interpreter state; and,
wherein the first method, or an additional method, can subsequently reactivate execution of the bytecode of the at least one further method by the secondary bytecode interpreter.

56. The article as claimed in claim 55, wherein the secondary bytecode interpreter resides in the primary virtual machine.

57. The article as claimed in claim 56, wherein the secondary bytecode interpreter is a bytecode module.

58. The article as claimed in claim 55, wherein the secondary bytecode interpreter resides outside the primary virtual machine.

59. The article as claimed in claim 58, wherein the secondary bytecode interpreter is a native code module.

60. The article as claimed in claim 55, wherein the interruption call is asynchronous.

61. The article as claimed in claim 55, wherein the secondary bytecode interpreter executes only specially marked methods.

62. The article as claimed in claim 55, wherein the secondary bytecode interpreter utilizes at least one object that contains execution context state.

63. The article as claimed in claim 55, wherein the secondary bytecode interpreter discriminates between methods to be executed by the secondary bytecode interpreter or delegated to the primary virtual machine.

64. The article as claimed in claim 55, wherein execution of the bytecode of the at least one further method is interruptable at any point.

65. The article as claimed in claim 55, wherein the interruption call is made externally to the secondary bytecode interpreter.

66. The article as claimed in claim 55, wherein the interruption call results from the at least one further method.

67. The article as claimed in claim 55, wherein the interruption call is activated by the secondary bytecode interpreter during bytecode interpretation.

68. The article as claimed in claim 55, wherein the additional method is executed at the same or another location as the first method.
